(19) United States
(12) Patent Application Publication
(10) Pub. No.: US 2023/0324878 A1
(43) Pub. Date: Oct. 12, 2023

(54) INFORMATION PROCESSING DEVICE, INFORMATION PROCESSING METHOD, AND COMPUTER PROGRAM PRODUCT

(71) Applicants: KABUSHIKI KAISHA TOSHIBA, Tokyo (JP); TOSHIBA INFRASTRUCTURE SYSTEMS & SOLUTIONS CORPORATION, Kawasaki-shi Kanagawa (JP)

(72) Inventors: Gaku ISHII, Kawasaki Kanagawa (JP); Shinichi NAGANO, Yokohama Kanagawa (JP); Suguru YOKOYAMA, Katsushika Tokyo (JP)

(73) Assignees: KABUSHIKI KAISHA TOSHIBA, Tokyo (JP); TOSHIBA INFRASTRUCTURE SYSTEMS & SOLUTIONS CORPORATION, Kawasaki-shi Kanagawa (JP)

(21) Appl. No.: 17/823,510

(22) Filed: Aug. 30, 2022

(30) Foreign Application Priority Data
Mar. 22, 2022 (JP) 2022-044895

(51) Int. Cl. G05B 19/406; G05B 19/408

(52) U.S. Cl. CPC G05B 19/4083; G05B 19/406; G05B 2219/34379

(57) ABSTRACT

According to an embodiment, an information processing device includes a memory and one or more processors coupled to the memory. The one or more processors configured to: receive rule data and system data, the rule data representing rules of monitoring control and including first state information among a plurality of pieces of state information by which states of monitoring control targets are expressed in a relation between two concepts, the system data including second state information among the plurality of pieces of state information and indicating a state of a first target included in a monitoring control system; determine a condition of collation between the pieces of state information; collate, in accordance with the condition, the first state information included in the rule data and the second state information included in the system data; and output a result of the collation to an output device.

### CROSS-REFERENCE TO RELATED APPLICATIONS

This application is based upon and claims the benefit of priority from Japanese Pat. Application No. 2022-044895, filed on Mar. 22, 2022; the entire contents of which are incorporated herein by reference.

### FIELD

Embodiments described herein relate generally to an information processing device, an information processing method, and a computer program product.

### BACKGROUND

Needs for further sophistication of automated operation have been increasing in a monitoring control system configured to perform monitoring control on facilities and the like included in a plant. For automated operation, for example, the state of a monitoring control target is sensed, and whether the sensed state is steady (normal) or non-steady (abnormal) is determined.

To achieve state sensing, collation is performed among a plurality of kinds of data used for monitoring control in some cases. For example, collation is performed between data (rule data) indicating a state corresponding to an IF condition of a monitoring control rule described in an IF-THEN format and a state corresponding to a THEN condition, and data (system data) indicating, for example, the state of each monitoring control target, which is obtained from a monitoring control system.

### BRIEF DESCRIPTION OF THE DRAWINGS

FIG. 1 is a block diagram of an information processing device according to an embodiment;

FIG. 2 is a diagram illustrating exemplary state information;

FIG. 3 is a diagram illustrating exemplary state information;

FIG. 4 is a diagram illustrating exemplary state information;

FIG. 5 is a diagram illustrating exemplary state information;

FIG. 6 is a diagram illustrating exemplary state information;

FIG. 7 is a diagram illustrating exemplary state information;

FIG. 8 is a diagram illustrating exemplary state information;

FIG. 9 is a diagram illustrating exemplary state information;

FIG. 10 is a diagram illustrating exemplary rule data;

FIG. 11 is a diagram illustrating exemplary rule data;

FIG. 12 is a diagram illustrating exemplary rule data;

FIG. 13 is a diagram illustrating exemplary system data;

FIG. 14 is a diagram illustrating exemplary system data;

FIG. 15 is a diagram illustrating exemplary system data;

FIG. 16 is a diagram illustrating exemplary system data;

FIG. 17 is a diagram illustrating exemplary system data;

FIG. 18 is a flowchart of collation processing in the embodiment;

FIG. 19A is a diagram illustrating exemplary data collation;

FIG. 19B is a diagram illustrating exemplary data collation;

FIG. 20 is a diagram illustrating exemplary rule data;

FIG. 21 is a diagram illustrating exemplary system data;

FIG. 22 is a diagram illustrating an exemplary designation screen;

FIG. 23 is a flowchart of collation processing in the embodiment;

FIG. 24 is a diagram illustrating exemplary ontology data;

FIG. 25 is a diagram illustrating processing of generating state information by using ontology data;

FIG. 26 is a diagram illustrating processing of generating state information by using ontology data;

FIG. 27 is a flowchart of generation processing in the embodiment;

FIG. 28 is a diagram illustrating exemplary rule data schemas;

FIG. 29 is a diagram illustrating an exemplary system data schema;

FIG. 30 is a diagram illustrating an exemplary display screen; and

FIG. 31 is a hardware configuration diagram of an information processing device according to the embodiment.

### DETAILED DESCRIPTION

According to an embodiment, an information processing device includes a memory and one or more processors coupled to the memory. The one or more processors are configured to: receive rule data and system data, the rule data representing rules of monitoring control and including one or more pieces of first state information among a plurality of pieces of state information by which states of one or more monitoring control targets are expressed in a relation between at least two concepts, the system data including one or more pieces of second state information among the plurality of pieces of state information and indicating a state of a first target included in a monitoring control system among the monitoring control targets; determine a condition of collation between the plurality of pieces of state information; collate, in accordance with the condition, the first state information included in the rule data and the second state information included in the system data; and output a result of the collation to an output device.

A preferable embodiment of an information processing device according to the present disclosure will be described below in detail with the accompanying drawings. The following description will be made with, as an example, a monitoring control system configured to perform monitoring control on a plant such as a water purification facility (water treatment facility), but an applicable system is not limited thereto.

In the monitoring control system, needs for sophistication of automated operation, such as expansion of the application range of automated operation in a non-steady situation have been increasing. The non-steady situation is, for example, a situation that cannot be formulated neither with a physical model nor with a chemical model (no causality principle of which is understood due to complication or the like), or a situation for which no machine learning model of significance can be established (learning data for which is insufficient due to rare occurrence).

The following two methods are mainly available as automated operation methods in the non-steady situation.

Automatically sense a non-steady state when the operation mode of the monitoring control system is switched from steady (automatic) to non-steady (manual).

Apply a rule (IF-THEN format) described in advance.

When a state regarded as non-steady is to be sensed by the monitoring control system, data (for example, the state flag of an explanatory variable) used for state determination needs to be selected from among a significantly large number of data items included in system data transmitted from the monitoring control system. For this, collation is performed between, for example, rule data representing rules of monitoring control and system data representing the state of each monitoring control target included in the monitoring control system.

Such a situation occurs in, for example, a case in which rule data production (rule description) and system data production (such as consolidation of data items as monitoring control targets) are independently executed.

No relevant data exists (no state flag is generated or no data is collected) depending on the monitoring control system. Accordingly, a large load is required for work of data association through exhaustive and reliable collation including data existence check.

Thus, in the present embodiment, both the rule data and the system data are expressed by using state information as the unit of data representing the state of each monitoring control target and are used for collation. For example, a pair of the rule data and the system data including identical or similar state information is extracted through collation. Accordingly, collation between the rule data and the system data can be more efficiently executed.

The following describes terms used in the present embodiment.

State information: the state information is a collection of relation data representing the state of a monitoring control target. For example, the state information is information by which states of one or more monitoring control targets are expressed in a relation between at least two concepts. The state information can be interpreted as a component (state information component) used in common to describe the rule data and the system data.

Monitoring control target: the monitoring control target is a target of a monitoring action and a control action in a monitoring control process. For example, the monitoring control target is water to be purified in monitoring control in a water purification process. More specifically, the monitoring control target is a component included in water to be purified. For example, chlorine injected as sterilization chemical is a component included in water to be purified. In this case, the monitoring control target is, for example, the concentration of chlorine.

Monitoring control target state: the monitoring control target state is a state as a basis for necessity for change of a control action in a monitoring control process. For example, the monitoring control target state is normality and abnormality. More detailed information such as the kinds of normality and abnormality may be used as the monitoring control target state. The kind of the relation between a measurement amount and a management amount of the monitoring control target may be used as the monitoring control target state. The relation between the measurement amount and the management amount is such that, for example, the measurement amount is within the range of the management amount (in other words, is determined to be normal). Normal is expressed as ordinary or steady in some cases. Abnormal is expressed as extraordinary or non-steady in some cases.

Management amount: the management amount is a concept (first concept) as a basis for determination of normal and abnormal states. For example, the management amount is a predetermined threshold value. When the management amount is a threshold value, the monitoring control target state is determined based on the kind of the relation between the measurement amount and the management amount, such as whether the measurement amount is equal to or over or equal to or under the management amount or whether the measurement amount is over or under the management amount. The management amount may be information indicating a range. When the management amount indicates a range, the monitoring control target state is determined based on the kind of the relation between the measurement amount and the management amount, such as whether the measurement amount is within or outside the range indicated by the management amount.

Relation data: the relation data is data representing the relation among a plurality of concepts. For example, the relation data is expressed as a network graph including a node and a link, the node being a concept, the link being the relation among a plurality of concepts and connecting a plurality of nodes. In the relation data, a concept, another concept, and the relation between the concepts may be expressed as a subject, an object, and a predicate that are interpretable in a natural language. For example, the relation data is expressed as a knowledge graph including a concept node as a subject (subject node), another concept node as an object (object node), and a relation link (predicate link) connecting the concept nodes as a predicate. The minimum unit of the relation data expressed as a network graph is graph data constituted by two nodes and a link connecting the two nodes. In this case, a collection of the relation data is a set of graph data. The relation data is not limited to expression as a network graph but may be expressed in another format such as a table.

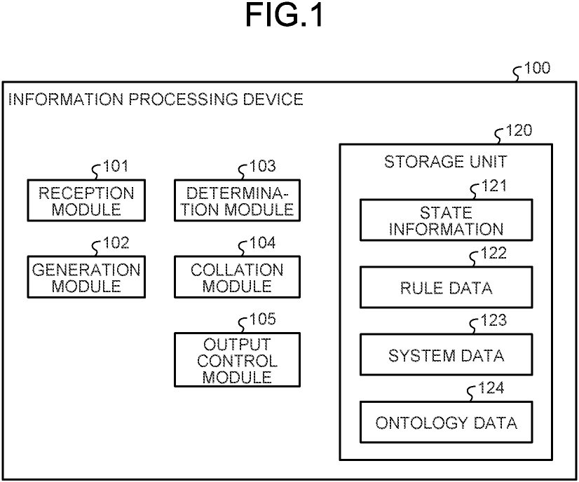

FIG. 1 is a block diagram illustrating an exemplary configuration of an information processing device 100 according to the present embodiment. As illustrated in FIG. 1, the information processing device 100 includes a reception module 101, a generation module 102, a determination module 103, a collation module 104, an output control module 105, and a storage unit 120.

The reception module 101 receives inputting of various kinds of information used in the information processing device 100. For example, the reception module 101 receives inputting of the rule data and the system data. The rule data is data representing rules of monitoring control and is set to include one or more pieces of the state information (first state information) among a plurality of pieces of state information. The system data is data representing the state of a monitoring control target (first target) included in the monitoring control system and is set to include one or more pieces of the state information (second state information) among the plurality of pieces of state information. When each piece of the state information is expressed as a network graph, the rule data and the system data may be each expressed as a network graph including one or more pieces of the state information.

The generation module 102 generates at least some of the state information, the rule data, and the system data. The information processing device 100 may include no generation module 102 when these pieces of data are generated by a device outside the information processing device 100.

The generation module 102 generates a plurality of pieces of state information by using, for example, ontology data prepared in advance. The ontology data is, for example, data representing a concept system between a plurality of concepts including the monitoring control target and the state of the monitoring control target.

The generation module 102 also generates the rule data including one or more pieces of the state information by using information indicating rules of monitoring control and a predetermined schema for the rule data. The schema is data representing the structure of rules of monitoring control. For example, the generation module 102 extracts, in accordance with the schema, a plurality of concepts from the information indicating rules of monitoring control and generates the rule data including the state information suitable for the extracted concepts among the plurality of pieces of state information.

The generation module 102 also generates the system data including one or more pieces of the state information by using information indicating the state of the monitoring control target and a predetermined schema for the system data. The schema is data representing the structure of data representing the state of the monitoring control target. For example, the generation module 102 extracts, in accordance with the schema, a plurality of concepts from the information indicating the state of the monitoring control target and generates the system data including the state information suitable for the extracted concepts among the plurality of pieces of state information.

The determination module 103 determines a condition (policy) of collation between the plurality of pieces of state information. The determination module 103 determines, as the collation condition, for example, a condition designated by a user on a designation screen for designating the collation condition. The condition is, for example, a condition indicating which of completely identical state information and similar state information is to be searched. Details of similar state information will be described later. The condition may be the range of network graph search.

The collation module 104 collates, in accordance with the determined collation condition, the state information included in the rule data and the state information included in the system data. Through the collation, for example, the system data suitable for the rule data is extracted from among the system data transmitted from the monitoring control system. The collation module 104 outputs a result of the collation to the output control module 105.

The output control module 105 controls outputting of various kinds of information from the information processing device 100. For example, the output control module 105 outputs the result of the collation by the collation module 104 to an output device. The output device may be any device and is, for example, a display device such as a display.

The output control module 105 may output text data generated based on the collation result. For example, when the state information is expressed as a knowledge graph, text data may be generated and output, the text data being expressed in a natural language including a subject expressed as a subject node, an object expressed as an object node, and a predicate expressed as a predicate link, which are included in the knowledge graph. In this case, the output control module 105 may associate and output the knowledge graph included in the collation result and the text data generated based on the knowledge graph.

The storage unit 120 stores various kinds of information used in the information processing device 100. For example, the storage unit 120 stores state information 121, rule data 122, system data 123, and ontology data 124. Some or all of these four kinds of data may be stored in a physically different storage medium (storage unit).

The storage unit 120 may be configured as any typically used storage medium such as a flash memory, a memory card, a random access memory (RAM), a hard disk drive (HDD), or an optical disk.

The above-described components (the reception module 101, the generation module 102, the determination module 103, the collation module 104, and the output control module 105) are achieved by, for example, one or a plurality of processors. For example, each above-described component may be implemented as execution of a computer program by a processor such as a central processing unit (CPU), in other words, as software. Each above-described component may be implemented as a processor such as a dedicated integrated circuit (IC), in other words, as hardware. Each above-described component may be implemented as software and hardware. When a plurality of processors are used, each processor may implement one of the components or two or more of the components.

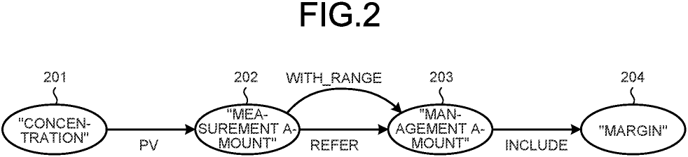

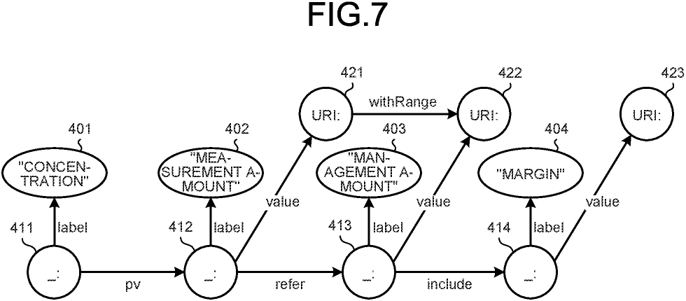

The following describes details of data used in the present embodiment. Exemplary state information will be described first. FIGS. 2 to 9 are diagrams illustrating exemplary state information. FIGS. 2 to 6 illustrate exemplary state information in a property graph format. FIGS. 7 to 9 illustrate exemplary state information in a resource description framework (RDF) format. The state information format is not limited to the property graph format nor the RDF format.

FIG. 2 illustrates exemplary state information indicating the state of concentration as an exemplary monitoring control target. The state information includes nodes 201 to 204. The nodes represent concepts as follows:
Node 201: concentration
Node 202: measurement amount
Node 203: management amount
Node 204: margin

An arrow representing a link representing the relation between a plurality of nodes is provided between the nodes. Each link is provided with information indicating the relation between the nodes connected through the link. For example, a link between the nodes 201 and 202 is provided with “PV” indicating the measurement amount (process variable (PV)). Information such as “SV (set variable)” indicating a setting amount or “MV (manipulative variable)” indicating an operation amount may be provided in place of “PV”.

“REFER” means that a link source (direction source) node refers to a link destination (direction destination) node. “INCLUDE” means that a link source node includes a link destination node.

“WITH_RANGE” is an exemplary kind (STATUS_RELATION) of the relation between a link source node and a link destination node and means that the link source node is within the range of the link destination node. The relation kind can have other values as follows:
Over (OVER)
Under (UNDER)
Equal to or over (OR_OVER)
Equal to or under (OR_UNDER)
Within the range (WITH_RANGE)
Outside the range (OUT_RANGE)
Out of management (NO_CONCERN)

The state information in FIG. 2 means a state in which “the measurement amount of concentration is within the range of the management amount”. The state information in FIG. 2 corresponds to exemplary state information including the minimum unit of a knowledge graph. The minimum unit of a knowledge graph is constituted by a concept node (subject node) as a subject, a concept node (object node) as an object, and a relation link (predicate link) as a predicate connecting the concept nodes. The relation link is a link directed from the subject node toward the object node.

In the example illustrated in FIG. 2, the node 202 is a subject node, the node 203 is an object node, and the link provided with “WITH_RANGE” is a predicate link. Such a knowledge graph can be expressed in a natural language (text data) by using a subject expressed by the subject node, an object expressed by the object node, and a predicate expressed by the predicate link. For example, text data that “the measurement amount (subject) is (predicate) within the range of the management amount (object)” can be generated for the state information in FIG. 2.

Each node and each link are provided with identification information (such as node ID and link ID) as property data. Each node and each link may additionally have one or more pieces of other property data. Exemplary property data are as follows:

(A1) Exemplary property data of a node
“name”: name of the node
“class”: identification information of the class (kind) of the node
“valueURI”: address at which data of the node exists (A2) Exemplary property data of a link
“name”: name of the link
“parts”: identification information of the corresponding state information
“status”: state of the link
“time”: timing of development of the link [such as tense or temporal interval]
“degree”: degree of development of the link [such as probability or frequency]
“ready”: existence of development of the link

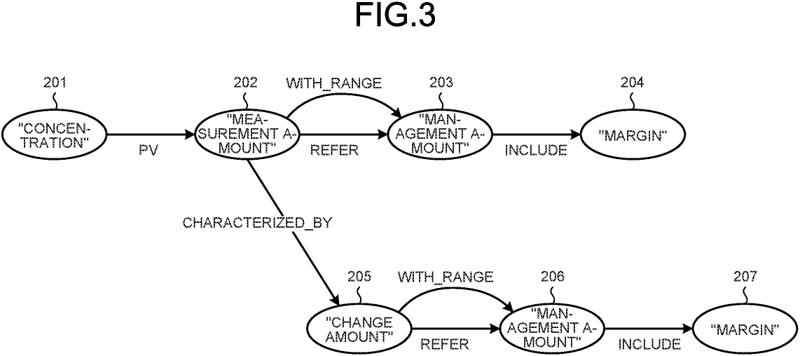

FIG. 3 illustrates exemplary state information meaning a state in which “the measurement amount of concentration and the change amount of the measurement amount are each within the range of the management amount”. In comparison with the state information in FIG. 2, a node 205 representing the change amount of the measurement amount and nodes 206 and 207 representing the management amount and margin corresponding to the node 205 are added. “CHARACTERIZED_BY” means that a link destination node includes characteristics (properties) of a link source node.

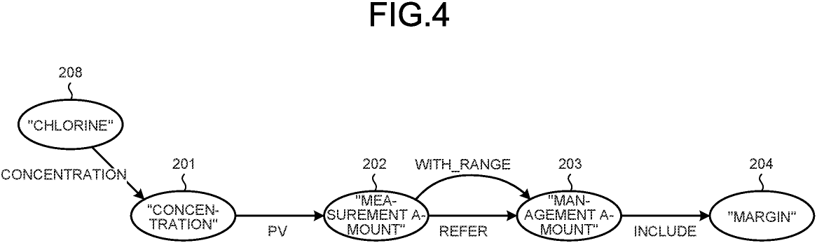

FIG. 4 illustrates exemplary state information meaning a state in which “the measurement amount of the concentration of chlorine is within the range of the management amount”. In comparison with the state information in FIG. 2, a node 208 meaning chlorine is added.

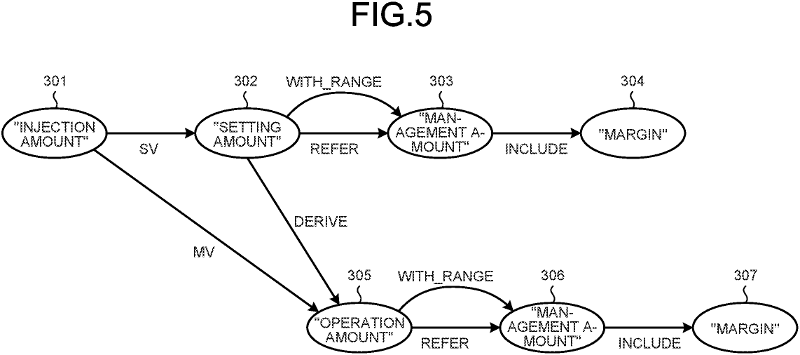

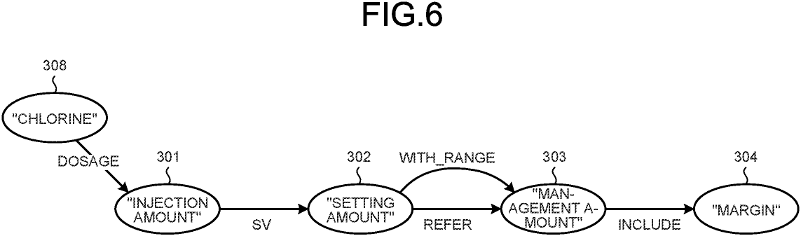

FIGS. 2 to 4 illustrate exemplary state information of states related to concentration. FIGS. 5 and 6 illustrate exemplary state information of states related to an injection amount. Specifically, FIG. 5 illustrates exemplary state information meaning a state in which “the setting amount and operation amount of the injection amount are each within the range of the management amount”.

The state information includes nodes 301 to 307 representing concepts as follows:
Node 301: injection amount
Node 302: setting amount
Node 303: management amount
Node 304: margin
Node 305: operation amount
Node 306: management amount
Node 307: margin

FIG. 6 illustrates exemplary state information meaning a state in which “the setting amount of the injection amount of chlorine is within the range of the management amount”. In comparison with the state information in FIG. 5, a node 308 meaning chlorine is added and nodes 305 to node 307 related to the operation amount are deleted.

The following describes exemplary state information in the RDF format with reference to FIGS. 7 to 9. FIGS. 7 to 9 correspond to the state information obtained by expressing, in the RDF format, the state information in the property graph format, which is illustrated in FIGS. 2 to 4, respectively.

For example, similarly to FIG. 2, FIG. 7 illustrates exemplary state information meaning a state in which “the measurement amount of concentration is within the range of the management amount”. The state information includes nodes 401 to 405 representing concepts as follows:
Node 401: concentration
Node 402: measurement amount
Node 403: management amount
Node 404: margin

In the state information in the RDF format, nodes and links have no property data, and instead, a node (property node) representing a property is added. When a plurality of properties are added to one node (for example, an object node), for example, a plurality of property nodes are added with an anonymous node as a hub.

In the example illustrated in FIG. 7, nodes 411 to 414 correspond to anonymous nodes. Nodes 421 to 423 are nodes representing addresses (uniform resource identifier (URI)) at which the values of the respective nodes 402 to 404 connected through the nodes 412 to 414 exist.

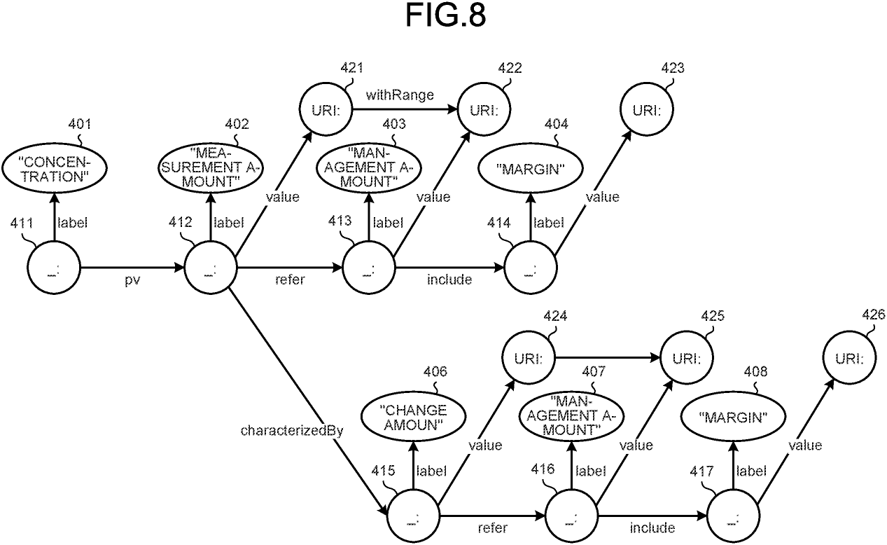

FIG. 8 illustrates exemplary state information meaning a state in which “the measurement amount of concentration and the change amount of the measurement amount are each within the range of the management amount”. In comparison with the state information in FIG. 7, nodes 406 to 408, 415 to 417, and 424 to 426 are added.

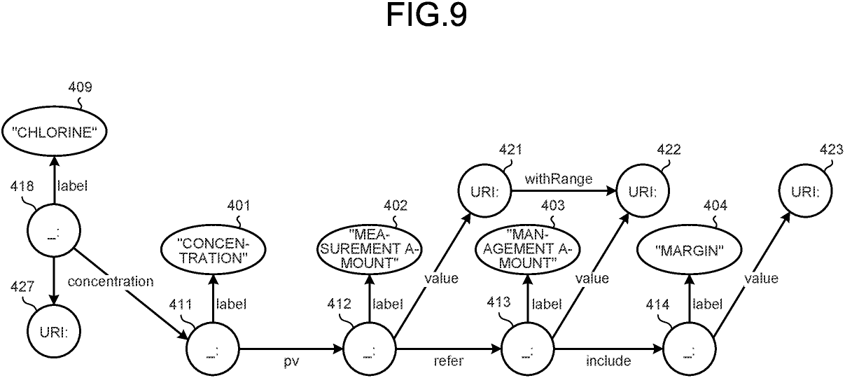

FIG. 9 illustrates exemplary state information meaning a state in which “the measurement amount of the concentration of chlorine is within the range of the management amount”. In comparison with the state information in FIG. 7, nodes 409, 418, and 427 are added.

The following describes exemplary configurations of the rule data and the system data. The following description is mainly made on exemplary rule data and exemplary system data set to include the state information in the property graph format. The rule data and the system data including the state information in the RDF format can be set through the same procedure based on consideration of the correspondence between the state information in the property graph format (FIGS. 2 to 4) and the state information in the RDF format (FIGS. 7 to 9).

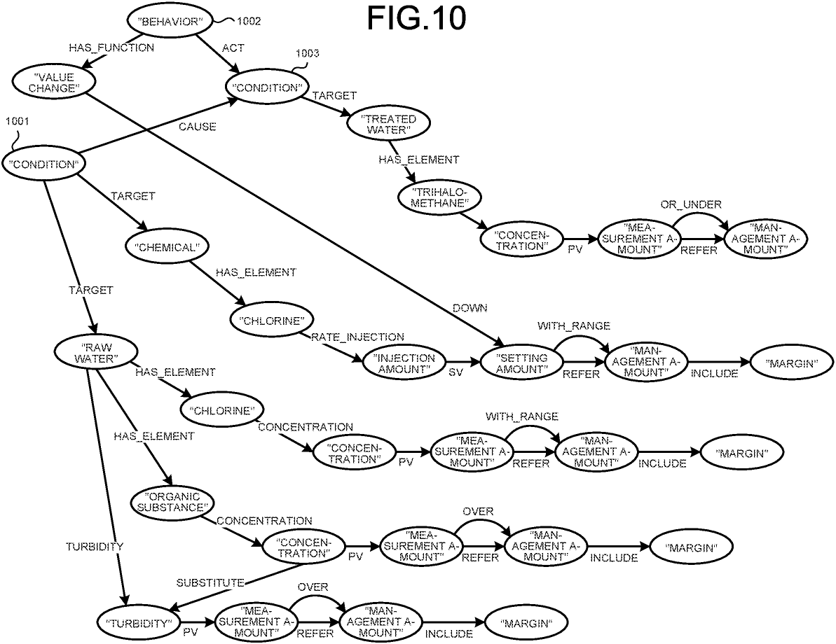

The following first describes exemplary rule data with reference to FIGS. 10 to 12. FIGS. 10 to 12 are diagrams illustrating the exemplary rule data.

The rule data is data in which the state information is combined and a rule is expressed in the IF-THEN format. For example, the rule data includes a concept node of an IF state, a concept node of a THEN state, a concept node (ACTION node) of a behavior (= action, effect, influence, or promotion) that is responsible for transition (performs transition or prompts transition) from the IF state to the THEN state, and a state transition relation link connecting the concept nodes.

The concept node of the IF state has a network graph constituted by the state information indicating the state of an IF condition at a time point A or a temporal interval A. The concept node of the THEN state has a network graph constituted by the state information indicating the state of a THEN condition at a time point B or a temporal interval B. The ACTION node has a network graph constituted by a relation link representing an action, effect, or influence on the state of an IF condition and a relation link representing promotion to the state of a THEN condition.

Relation links related to state transition and included in the rule data are mainly classified into two kinds (L1 and L2) as follows:

(L1) Relation link representing state transition from the concept node of the IF state to the concept node of the THEN state:
(Concept node of the IF state → Concept node of the THEN state)
CAUSE: cause (= “become” the state of a THEN condition) (L2) Relation link from the ACTION node, meaning a behavior for state transition
(ACTION node → Concept node of the THEN state)
ACT: actuate (= “make” the state of a THEN condition)
(ACTION node → Concept node of the IF state)
Relation link related to change operation of a concept that is a measurement amount, a statistic amount, a target amount, or an operation amount (second concept; mainly the target amount and the operation amount) as an action, effect, or influence target
Example) DOWN: lower, reduce
Example) UP: rise, increase
Example) NULL: reduce to zero

In FIG. 10, nodes 1001, 1002, and 1003 correspond to the concept node of the IF state, the ACTION node, and the concept node of the THEN state, respectively. Specifically, the nodes represent concepts as follows:

(N1) Concept node of the IF state (node 1001)
The setting amount of the injection amount of chlorine in chemical is within the range of the management amount
The measurement amount of the concentration of chlorine in raw water is within the range of the management amount
The measurement amount of the turbidity of organic substance in raw water exceeds the management amount (N2) ACTION node (node 1002)
Value change (lower the setting amount of the injection amount of chlorine in chemical)

(N3) The concept node of the THEN state (node 1003)
The measurement amount of the concentration of trihalomethane in treated water is equal to or under the management amount

These nodes are connected through links (such as CAUSE and ACT), and accordingly, the rule data in FIG. 10 means rules as follows:
“In a state in which the concentration of organic substance in raw water exceeds the management amount (IF),
when the setting amount of the injection amount of chlorine in chemical is lowered (ACTION),
the concentration of trihalomethane in treated water becomes equal to or under the management amount (THEN)”

In FIG. 10, the relation data as follows is added, the relation data meaning “the turbidity of raw water is substituted into the concentration of organic substance (= the property of turbidity is substituted into the property of concentration (= turbidity is substituted into concentration))”. For example, when the concentration of organic substance cannot be measured, the turbidity of raw water is substituted into the measurement in some cases, and the relation data indicates an example of such a case.
Link source node: “concentration”
Relation link: SUBSTITUTE (substitute)
Link destination node: “turbidity”

In this manner, the rule data of the present embodiment can be converted into text data expressed in a natural language.

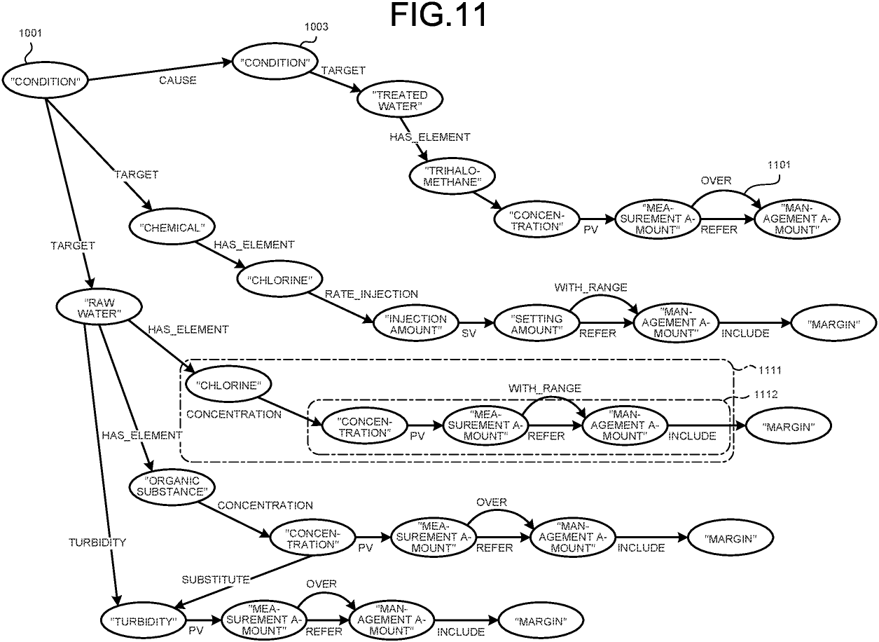

FIG. 11 illustrates exemplary rule data including no ACTION node. The rule data illustrated in FIG. 11 is the rule data in FIG. 10 from which the node 1002 and nodes and links related to the node 1002 are deleted. In addition, a link representing the relation between the measurement amount and the management amount of the concentration of trihalomethane is changed to a link 1101 meaning “OVER (excess)”.

The rule data in FIG. 11 means rules as follows:
“In a state in which the concentration of organic substance in raw water exceeds the management amount (IF),
the concentration of trihalomethane in treated water exceeds the management amount (THEN)”

As illustrated in FIGS. 10 and 11, in the rule data, each graph having a root at a condition (IF condition or THEN condition) of a rule in the IF-THEN format is expressed by combining one or more pieces of the state information. The state of an IF condition as a combination of one or more pieces of the state information can be understood as a form of the state information. In this case, the rule data may include a graph having a root at an IF condition as a combination of two or more IF conditions.

“TARGET” means that a link source node (such as a condition) has a target (monitoring control target) at a link destination node. “HAS_ELEMENT” means that a link source node has a link destination node as an element (for example, a more specific monitoring control target).

A graph 1112 in FIG. 11 is an exemplary graph that can be a basic unit of the state information. The basic unit of the state information is a collection of the relation data constituted by nodes of concepts as follows:
Node representing the kind (such as concentration, turbidity, or injection amount) of an industrial amount (physical quantity) as a monitoring control target
Node representing the measurement amount, statistic amount, target amount, or operation amount of a monitoring control target
Node representing the management amount of a monitoring control target

A node representing a margin does not necessarily need to be included in the basic unit but may be optional, or may be included in the basic unit. When the margin is included in the basic unit, absence of the margin is clearly indicated for a target having no margin. The margin may be clearly indicated by methods as follows:
Clearly indicate by using a property of a node (for example, null a property related to the value of the margin)
Clearly indicate by using the kind of a link (for example, set “NO_CONCERN” to a relation link with a node of the management amount)

With indication of an industrial amount (for example, concentration) only, an entity as a measurement target of the concentration is unknown. Thus, data (rule data and system data) using the state information needs to additionally include an entity as a measurement target of an industrial amount. In the following description, the state information including an entity as a measurement target of an industrial amount is referred to as a state information entity in some cases. For example, in FIG. 11, a graph 1111 is an exemplary graph that can be the state information entity.

The state information entity includes a node representing a monitoring control target (entity as a measurement target of an industrial amount) related to the domain of the monitoring control system. The state information entity exists for each state kind, in other words, for each kind of the relation with the management amount.

The graph 1111 is an exemplary state information entity having a root at a node meaning chlorine. Such a state information entity is an example having a root at a node as the object of a relation link of “HAS_ELEMENT”.

The state information entity may have a root at a node (of a link destination) as the object of a relation link of “TARGET”. In the example illustrated in FIG. 11, such a state information entity is a graph having a root at raw water.

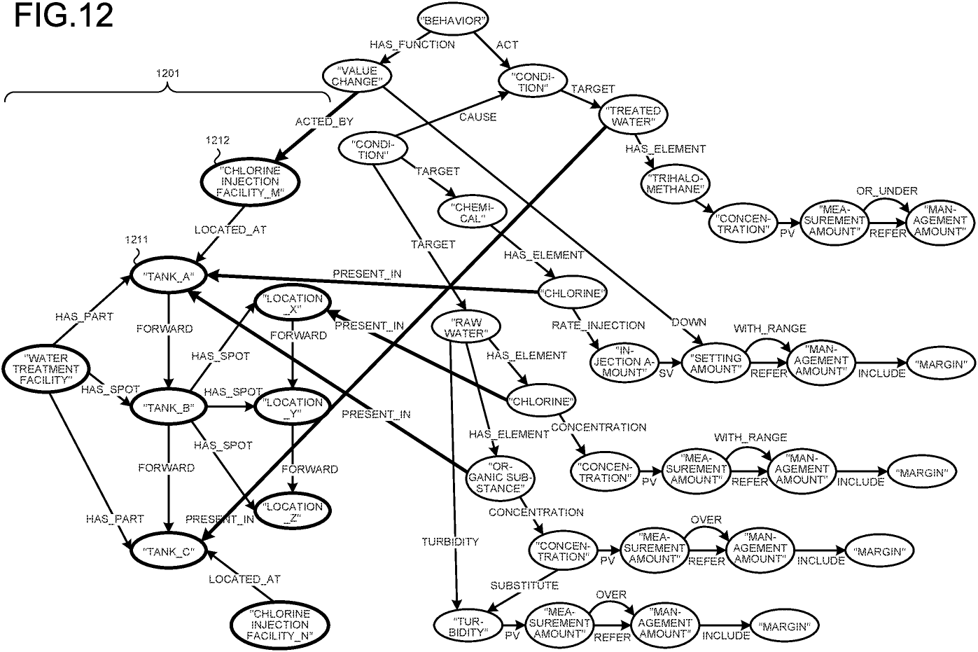

FIG. 12 illustrates exemplary rule data including a relation link to a node (location node) representing a concept of a location. The location node is a node representing the location of a state. The location of a state indicates, for example, a location at which a monitoring control target of the state exists. The location of a state may be, for example, a location at which a facility as a monitoring control target is installed, or a location at which an industrial amount as a monitoring control target is measured.

In FIG. 12, a graph 1201 indicates an exemplary graph including a location node. A location node 1211 corresponds to a node representing a location “tank_A” in a water purification facility. In the example illustrated in FIG. 12, it is indicated that the concentration of chlorine and the concentration of organic substance at the location “tank_A” represented by the location node 1211 are monitoring control targets. A node 1212 is a node representing that a value change action (for example, chlorine injection) by using a “chlorine injection facility_M” is performed on the location node 1211.

Examples of a link representing the relation with a location node or a node representing the actor (facility) of an action, such as the node 1212 are described below.
PRESENT_IN: exists
   Example: chlorine in raw water exists at a “location_X” of a “tank_B” in a water purification facility
ACTED_BY: executed
   Example: a value change is executed by the “chlorine injection facility_M” (the “chlorine injection facility_M” executes the value change)
LOCATED_AT: installed
HAS_PART: has a component part
   Example: the water purification facility has the component part “tank_A” (the “tank_A” is located at the water purification facility)
HAS_SPOT: has a component spot
   Example: the “tank_B” has the component spot “location_X” (the “location_X” is located at the “tank_B”)

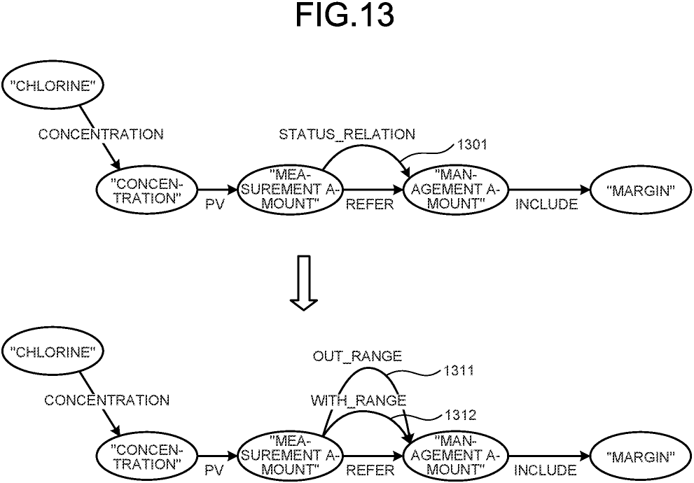

The following describes exemplary system data with reference to FIGS. 13 to 17. FIGS. 13 to 17 are diagrams illustrating exemplary system data.

FIG. 13 illustrates exemplary system data representing data (such as alert) that the state of the measurement amount of the concentration of chlorine is determined. A relation link 1301 provided with “STATUS_RELATION” means that any of kinds of a relation link representing the relation with the management amount is allocated. For example, a relation link representing any of kinds described below may be set to the relation link 1301.
Non-steady situation: OUT_RANGE (relation link 1311)
Steady situation: WITH_RANGE (relation link 1312)

In the example illustrated in FIG. 13, a plurality of relation links of opposite kinds are provided. As described below, a state can be identified by providing, as the property data of each relation link, information with which it can be identified whether the state is non-steady or steady.
Property data of OUT_RANGE (relation link 1311): status = “non-steady”
Property data of WITH_RANGE (relation link 1312): status = “steady”

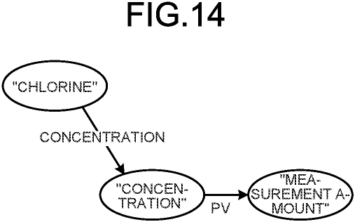

The system data may include data corresponding to part of the state information. FIG. 14 illustrates exemplary system data including data corresponding to part of the state information. As illustrated with the graph 1112 in FIG. 11, the basic unit of the state information includes a node representing the kind of an industrial amount, a node representing a measurement amount or the like, and a node representing a management amount. Accordingly, for example, data in which the measurement amount is recorded includes neither a node representing a management amount nor a relation link to the node and thus is not the state information but corresponds to part of the state information. In the following description, such data is referred to as a “state information source” in some cases. The state information source is information including a concept (second concept) as any of a measurement amount, a statistic amount, a target amount, and an operation amount.

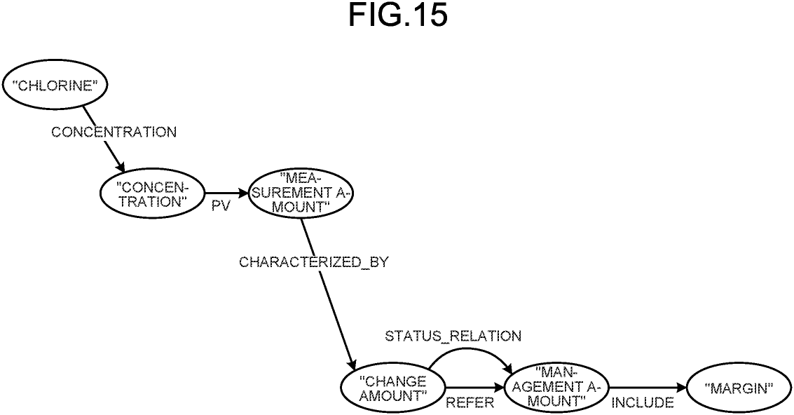

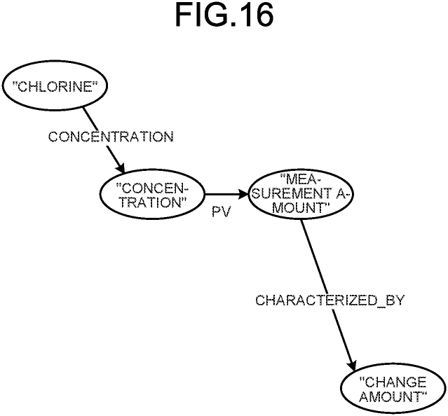

FIG. 15 illustrates exemplary system data representing data (such as alert) that the state of the change amount of the concentration of chlorine is determined. FIG. 16 illustrates exemplary system data representing data as the state information source corresponding to the data illustrated in FIG. 15. The data described with reference to FIG. 14 indicates data as the state information source corresponding to the data illustrated in FIG. 15.

FIG. 17 illustrates exemplary system data including a location node and a relation link to an entity as a measurement target of an industrial amount. The graph 1201 indicates an exemplary graph including the same location node as in FIG. 12. A graph 1701 indicates an exemplary graph including a node representing an entity as a measurement target of an industrial amount.

Exemplary links representing the relation with a location node or a node representing an entity as a measurement target of an industrial amount are described below.
PRESENT_IN: exists
   Example: chlorine exists at the “location_X” of the “tank_B” in the water purification facility
DEFINED_BY: defined
   Example: “data_r4” is defined by the state information having a root at chlorine (interpreted as data representing the state of the concentration of chlorine)
HAS_PART: has a component part
   Example: “field_R” has a component part “data_r0” (“data_r0” exists in “field_R”)

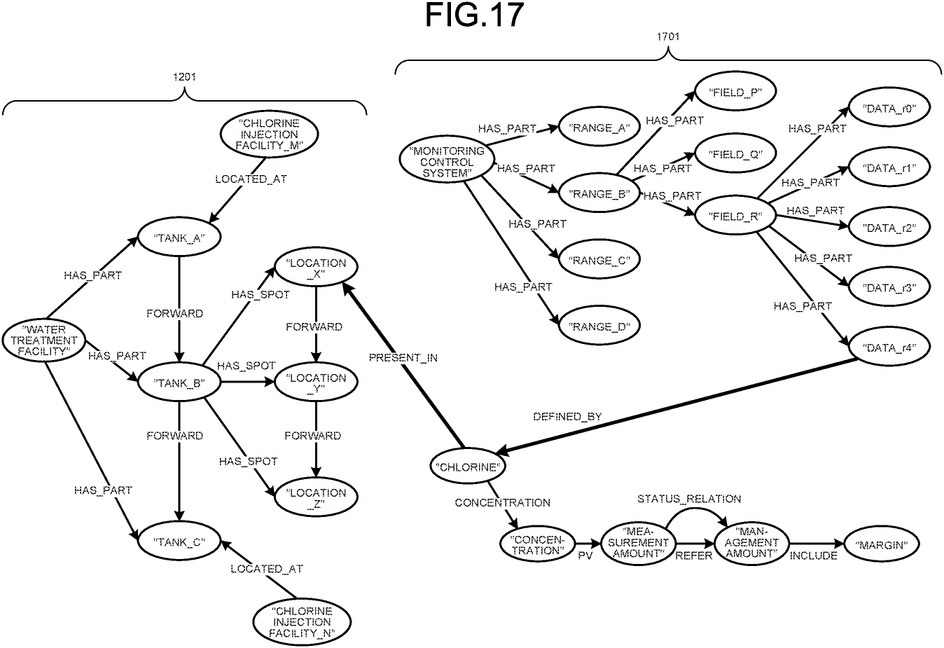

The following describes collation processing performed by the information processing device 100 according to the present embodiment with reference to FIGS. 18 to 23. FIG. 18 is a flowchart illustrating exemplary collation processing in the present embodiment. The collation processing is received by, for example, the reception module 101 and collates one or more pieces of the rule data 122 and at least one piece of the system data 123 stored in the storage unit 120.

The collation module 104 collates the rule data 122 and the system data 123 and extracts the rule data 122 and the system data 123 having identical monitoring control targets (step S101). For example, the collation module 104 specifies a monitoring control target, the state of which is indicated by one or more pieces of the state information included in the rule data 122 designated as a collation starting point (collation source) by the user or the like. The collation module 104 extracts, from the system data 123 stored in the storage unit 120, one or more pieces of the system data including the state information indicating the state of a monitoring control target identical to the specified monitoring control target.

Subsequently, the collation module 104 extracts, from among the extracted system data 123, the system data 123 including a location node representing a location identical to a location node included in the rule data 122 (step S102).

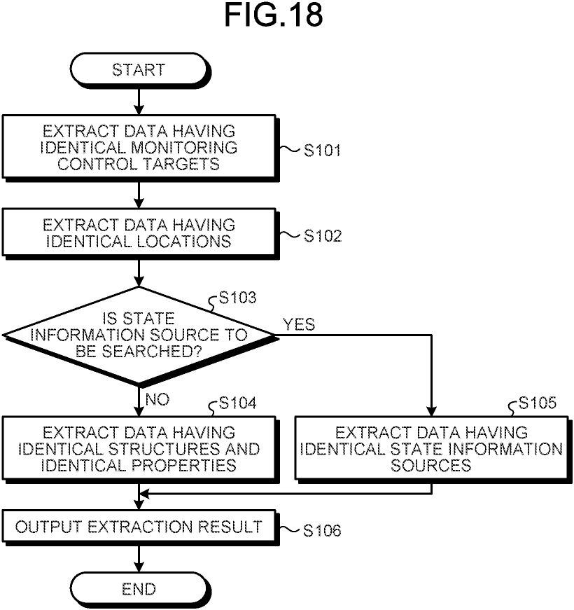

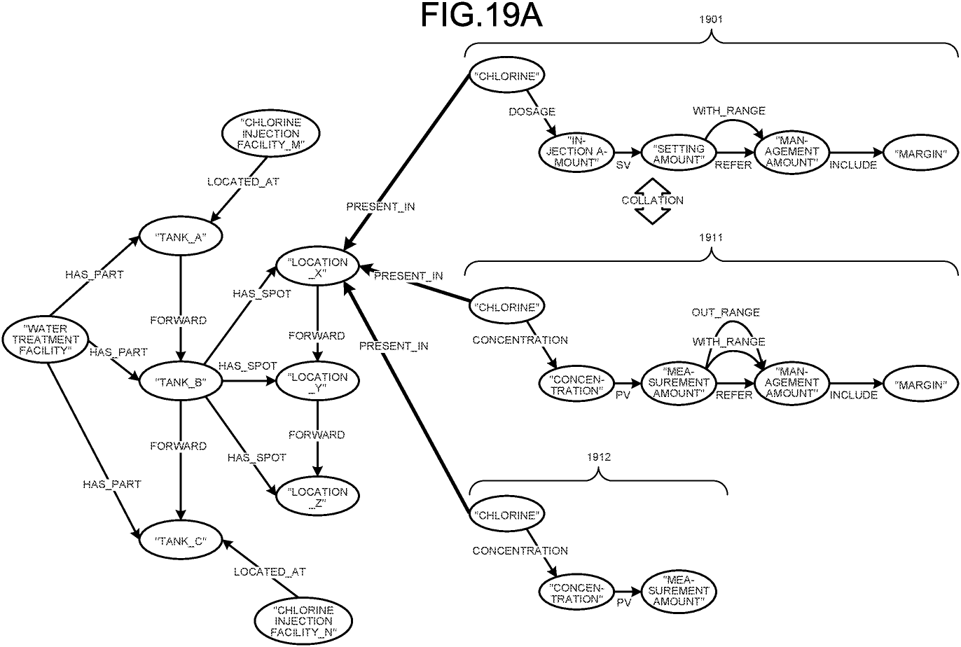

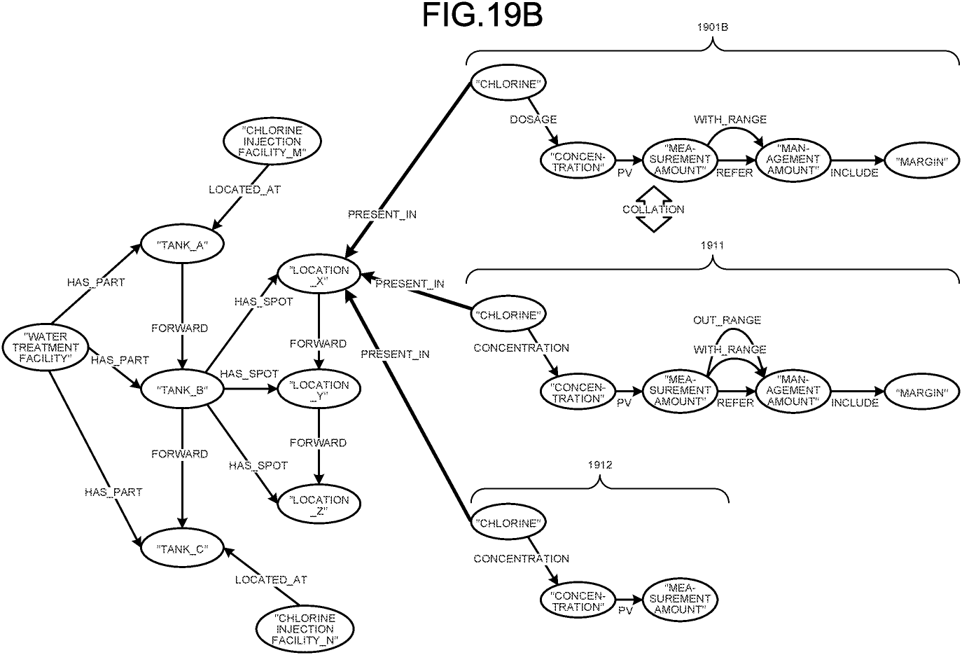

FIGS. 19A and 19B are diagrams illustrating exemplary collation of data having identical locations. FIG. 19A illustrates an example in which system data 1911 and 1912 are extracted for rule data 1901 having chlorine as a monitoring control target, part of the monitoring control target and location being identical among the data. FIG. 19B illustrates an example in which the system data 1911 and 1912 are extracted for rule data 1901B having chlorine as a monitoring control target, the monitoring control target and location being identical among the data.

Back in FIG. 18, the collation module 104 determines whether to search for the state information source (step S103). For example, the collation module 104 determines whether to search for the state information source based on whether the collation condition determined by the determination module 103 indicates search for a state information source.

When the state information source is not to be searched (No at step S103), the collation module 104 extracts the system data 123 among which structure and property (state) are identical from among the system data 123 extracted so far (step S104). For example, the collation module 104 extracts the system data 123 having a structure identical to that of the state information of the rule data 122 and including property data representing a state identical to a state (for example, the above-described “status”) indicated by property data included in the state information.

The structure identity means, for example, identity in the number of nodes included in a data graph and identity in the position and orientation of links connecting nodes. The property identity means, for example, identity in a particular property (for example, a node class) among properties provided to a node or identity in a particular property (for example, a link class) among properties provided to a link. It may be regarded that structures and properties are identical when the structures and the properties are not completely identical but, for example, the structure of the system data includes the structure of the rule data, and properties of nodes and links in the range of the inclusion are identical. When a node representing a margin is optional in the basic unit of the state information, the node may be a non-collation target.

When the state information source is to be searched (Yes at step S103), the collation module 104 extracts the system data 123 among which the state information source is identical from among the system data 123 extracted so far (step S105). For example, the collation module 104 extracts the system data 123 including the state information source identical to the state information source corresponding to part of the state information of the rule data 122. The collation (extraction) of the system data including the identical state information sources corresponds to collation of the state information among which the graph structure is partially identical, in other words, the state information similar to one another.

The similar state information is, for example, the state information among which at least one of the graph structure and a property provided to nodes and links included in the graph is similar. For example, the graph structure similarity does not mean identity in the complete graph structure but means identity in part of the graph structure. The property similarity means that a plurality of properties have the same kind of meaning or property, and for example, means identity in a particular property (for example, a class) among properties provided to nodes and links included in the graph.

Exemplary similar state information is described below.
(Example 1) State information among which part of the graph is identical (=state information among which part of the graph structure is identical and a particular property (for example, a class) among properties provided to nodes and links in the identical part of the graph is identical)
(Example 2) State information among which the graph structure is identical, a particular property (for example, a class) among properties provided to nodes or links in part of the graph is similar, and the particular property is identical at the other nodes and links
(Example 3) State information having the features of Example 1 as well as the features of Example 2 (= state information among which part of the graph structure is identical, a particular property (for example, a class) among properties provided to nodes or links at the identical part of the graph is similar, and the particular property is identical at the other nodes and links)

The state information source identity corresponds to an example of the state information among which part of the graph is identical, in other words, the above-described example 1 or 3.

The system data 1911 in FIGS. 19A and 19B is exemplary system data that is not completely identical to the rule data 1901 but can be regarded as identical in structure and property. The system data 1912 is exemplary system data that is identical to the rule data 1901 in state information source.

Back in FIG. 18, the output control module 105 outputs a result of the extraction (result of the collation) by the collation module 104 to the output device such as a display (step S106), and ends the collation processing.

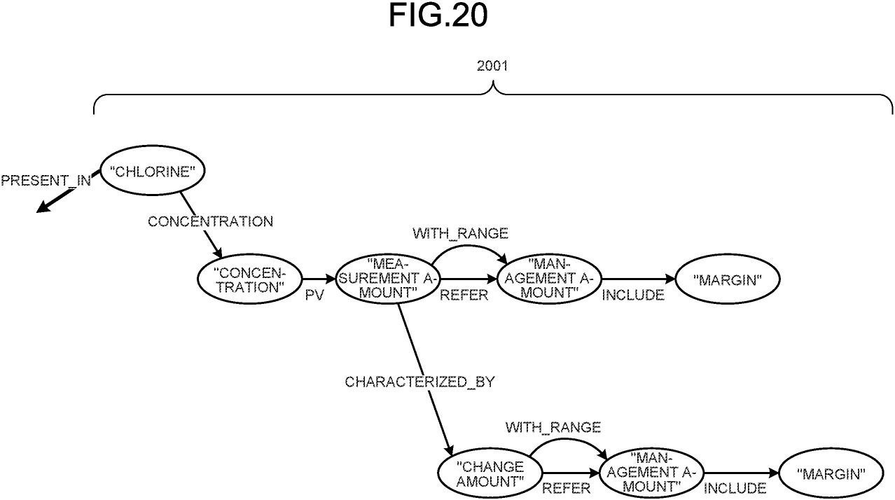

The following describes other exemplary collation. FIG. 20 is a diagram illustrating exemplary rule data 2001 as a collation source. FIG. 21 illustrates exemplary system data 2101 to 2104 extracted as data with which the state information source is identical as a result of collation with the rule data 2001.

The system data can be regarded as the “state information source” when the system data includes a graph having a root at a node of the same monitoring control target (chlorine) as in the rule data 2001 and extending to a node representing an amount (measurement amount) that is compared with reference to the management amount. The system data 2101 to 2104 each include a node representing chlorine as a monitoring control target, a node representing an industrial amount (concentration), and a node representing a measurement amount and thus can be regarded as the state information source of the rule data 2001. For example, in the relation data having a relation link (predicate link) of “REFER”, the measurement amount has a meaning that “with reference to the management amount”. In the relation data of a relation link (predicate link) of “OVER” or the like, the measurement amount has a meaning that “exceeds in comparison with the management amount”.

Although FIG. 21 illustrates an exemplary node representing a measurement amount, the same collation can be performed with the system data including a node representing a statistic amount, a target amount, or an operation amount.

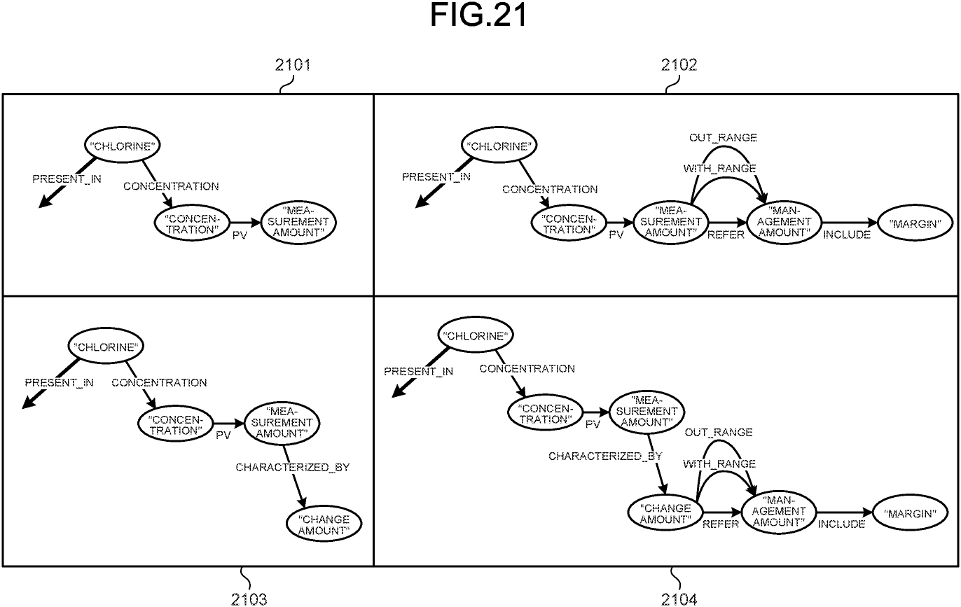

The following describes an exemplary collation condition designation method. FIG. 22 is a diagram illustrating an exemplary designation screen 2201 for designating a collation condition.

A target regarded to be similar and a starting point of collation can be designated on the designation screen 2201. The target regarded to be similar is designated by a search range. The starting point of collation indicates data as a collation source.

Any of the rule data and the system data can be designated as the starting point of collation on the designation screen 2201. The search range is designated by, for example, whether to search for a concept at a level equivalent to the level of data (node) designated as the starting point or a concept at a higher level, or the distance (such as the number of relation links) between the node designated as the starting point and a search target node.

In FIG. 22, a node denoted by “A” (hereinafter referred to as a node “A”) represents the node designated as the starting point. For example, the node “A” corresponds to the root node of the rule data as the starting point of collation. Nodes (hereinafter referred to as nodes “B”, “C”, and “D”) denoted by “B”, “C”, and “D” each correspond to the root node of the system data collated with the node “A”.

The search range of each node for the node “A” is as described below.
Node “B”: sibling, and two higher
Node “C”: parent and one generation
Node “D”: (parent and one generation) and (relative and one lower)

The target regarded to be similar (search range) is not limited to those described above. For example, at least one of the range of similar property and the range of similar structure may be searched.

For example, properties as follows may be adjusted to the same unit and included as the range of similar property in the search range even when their values are not completely identical.
Time for which an amount is calculated (for example, one minute and five minutes are handled as times having the same meaning such as “short time”)
Period in which an amount is calculated (for example, each one minute and each five minutes are handled as periods having the same meaning such as “short period”)

When nodes (concepts) do not have completely identical meanings but have the same kind in, for example, the ontology data, the nodes may be regarded as “similar in structure and property” and included in the search range. For example, concepts as follows can be regarded as not completely identical but similar.
Management amount (upper limit extreme) and management amount (upper limit reference)
Management amount (common to all systems), the management amount (common to systems having the same configuration pattern), and management amount (individually for each system)

Whether the range of similar property and the range of similar structure are included in the search range may be designated by the user through, for example, the designation screen 2201 in FIG. 22.

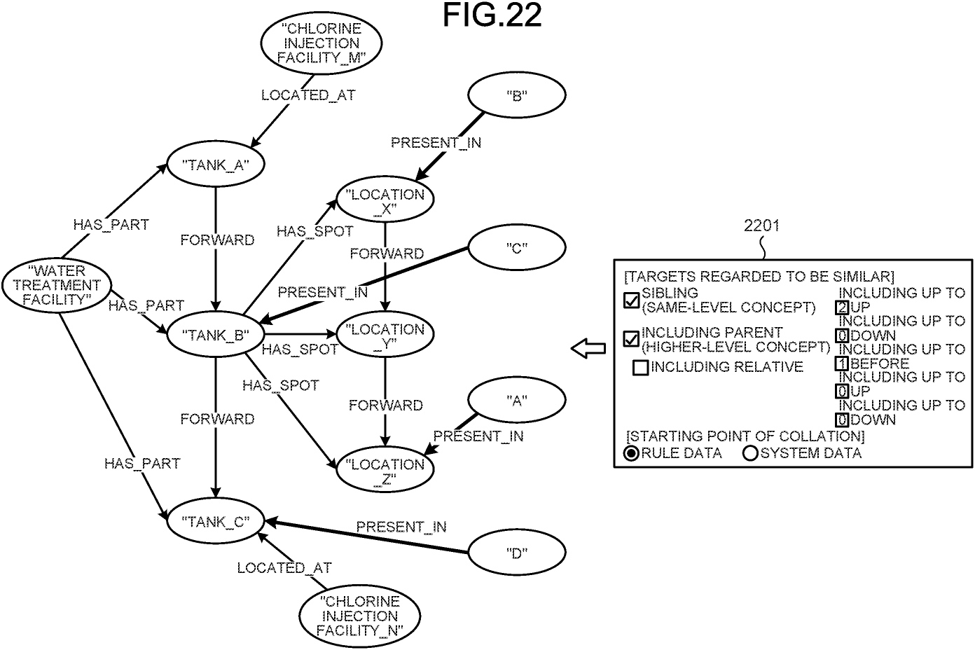

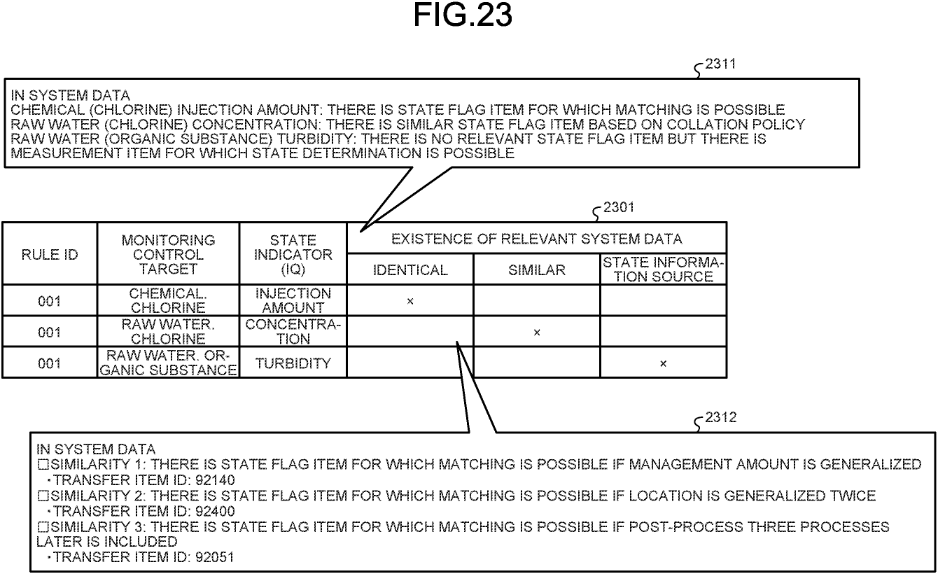

The following describes exemplary display of a result of collation by the output control module 105. FIG. 23 is a diagram illustrating an exemplary display screen 2301 for displaying the collation result. The display screen 2301 is an example in which a rule ID, a monitoring control target, a state indicator (IQ), and the existence of relevant system data are displayed in a table format.

The rule ID is identification information of the rule data as a collation source. The state indicator is an indicator used for state determination. The state indicator can be interpreted as a monitoring control target.

The existence of relevant system data is indicated in a manner divided into identical system data, similar system data, and system data for which the state information source is identical. A symbol “x” indicates that relevant system data exists.

A message 2311 is exemplary information indicating the collation result. A message 2312 is exemplary information indicating details of similar data. The output control module 105 may display the message 2311 and the message 2312 together with the display screen 2301 or on a screen different from the display screen 2301.

The following describes exemplary state information, rule data, and system data generation methods.

FIG. 24 is a diagram illustrating exemplary ontology data used for state information generation. FIG. 24 illustrates part of the ontology data related to a property that a concept has. The ontology data is a kind of the relation data (data representing the relation among a plurality of concepts).

Exemplary links used in the ontology data are described below.
“hasType”: a link source node (concept) has a property (“Property”) indicated at a link destination node (concept)
“hasSubProperty”: a link source node (concept) has a more detailed property (“Property”) indicated at a link destination node (concept)

The ontology data is also referred, for example, when whether a “node has the same kind” or “has a similar property” is determined to calculate the target regarded to be similar (search range).

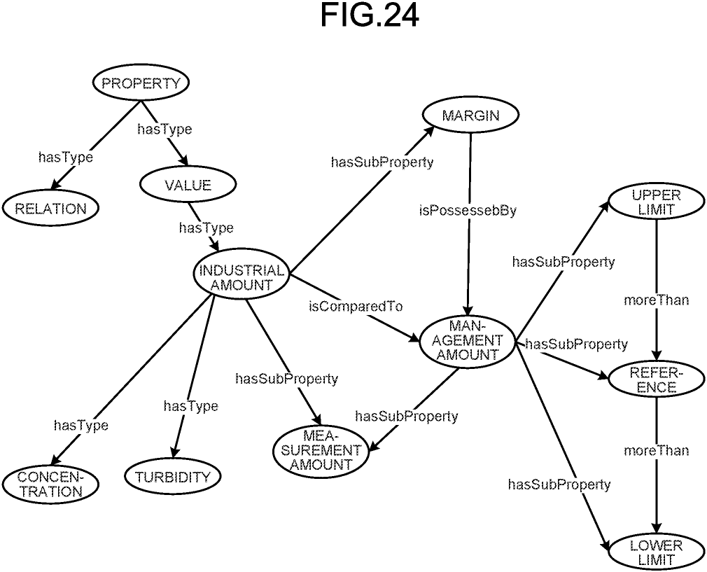

FIG. 25 is a diagram illustrating exemplary processing of generating new state information by using the ontology data as illustrated in FIG. 24.

First, the generation module 102 adds new relation data to the ontology data. For example, the generation module 102 adds a node 2501 representing “extreme upper limit” as a node (concept) that provides more details to a management amount. Subsequently, the generation module 102 searches, for example, the state information 121 stored in the storage unit 120 for the existing state information including a concept node at the same level as the added concept node. In the example illustrated in FIG. 25, the existing state information including a concept “upper limit” at the same level is searched. The generation module 102 generates new state information by replacing a concept node at the same level, which is included in the searched state information, with the added concept node.

When there is no state information including a concept node at the same level as the added concept node, the generation module 102 may perform additional search for a concept node at a level higher than the added concept node (for example, the link source node of the relation link “hasSubProperty”).

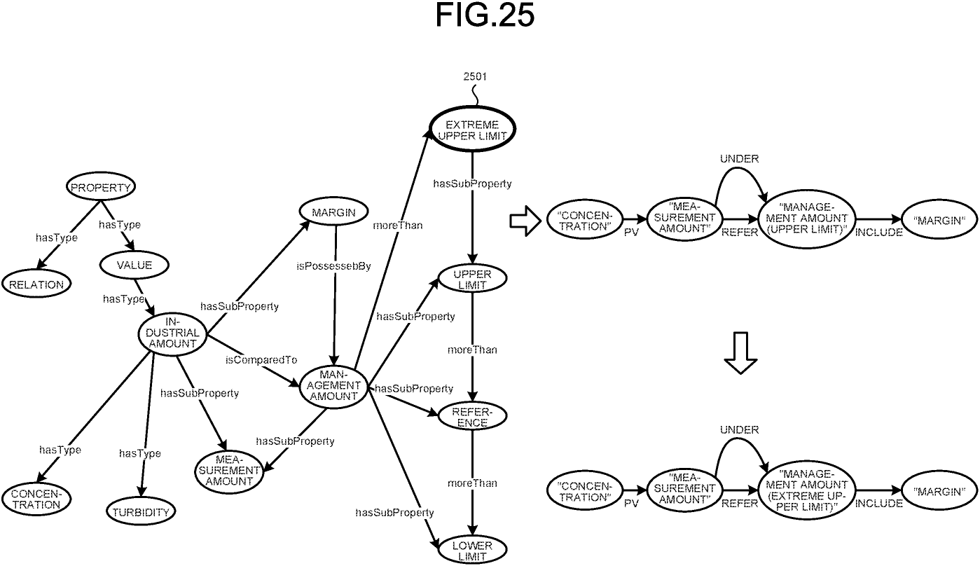

FIG. 26 is a diagram illustrating other exemplary processing of generating new state information by using the ontology data as illustrated in FIG. 24.

First, the generation module 102 adds new relation data to the ontology data. For example, the generation module 102 adds a node 2601 representing “temperature” as an industrial amount type. Subsequently, the generation module 102 searches, for example, the state information 121 stored in the storage unit 120 for the existing state information including a concept node at the same level as the added concept node. In the example illustrated in FIG. 25, the existing state information including a concept “concentration” at the same level is searched. The generation module 102 generates new state information by replacing a concept node at the same level, which is included in the searched state information, with the added concept node.

The above description is made on exemplary generation of the state information including, as a new node, a node (FIG. 25) related to a management amount or a node (FIG. 26) related to an industrial amount. The same procedure is also applicable to generation of the state information including a node representing a monitoring control target as a new node. For example, the above-described same procedure is also applicable to a case in which a node having “chlorine” as a monitoring control target is replaced with a node representing “activated carbon”.

The output control module 105 may display the generated state information to the user. For example, the output control module 105 displays a network graph illustrating the generated state information, and text data in which the contents of the state information are expressed in a natural language.

When registration is designated by the user for the generated information thus displayed, the generation module 102 may store the generated state information in, for example, the state information 121 in the storage unit 120.

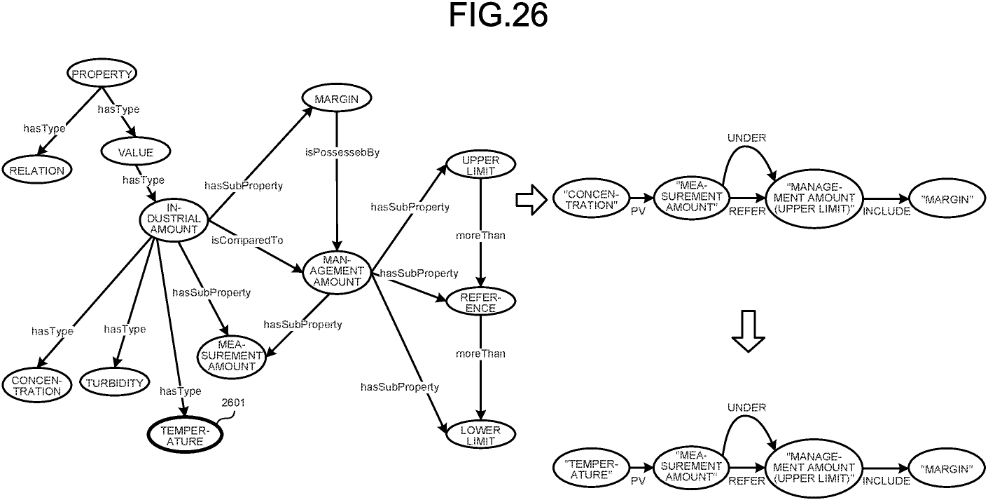

The following describes rule data generation processing. FIG. 27 is a flowchart illustrating exemplary generation processing in the present embodiment.

The reception module 101 receives inputting of original data as a rule data generation source (step S201). The original data is rule data related to monitoring control and having an IF-THEN structure and is described, for example, in a text format or a table format.

The generation module 102 extracts, from the original data, an element (concept element) as a concept of the state information in accordance with the predetermined schema for the rule data (step S202). The concept element is, for example, information as follows:
Element 1: concept of monitoring control target
Element 2: concepts of measurement amount, target amount, and operation amount
Element 3: concepts of management amount and margin
Element 4: concept of relation between Elements 2 and 3
Element 5: concepts of behaviors such as action, effect, and influence

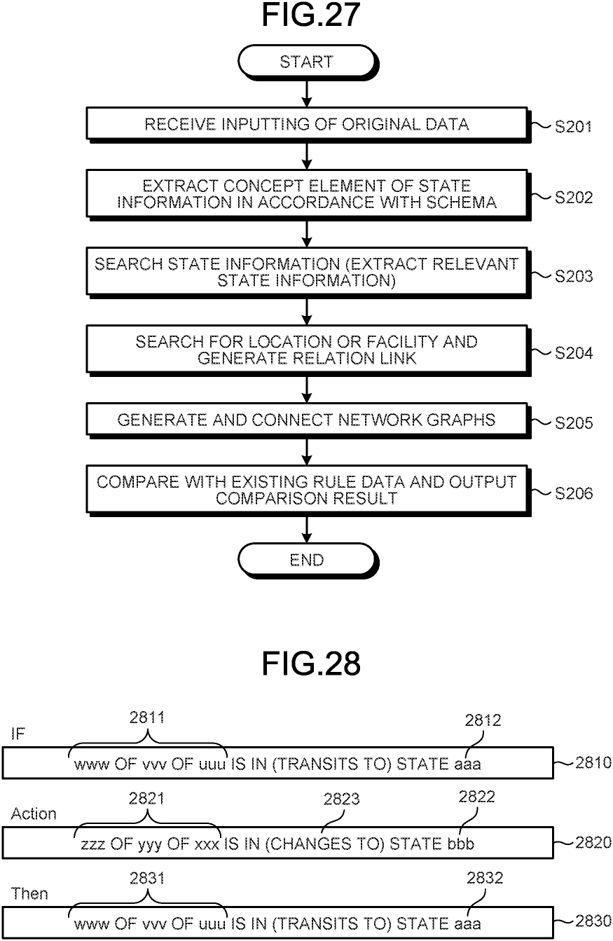

FIG. 28 is a diagram illustrating exemplary rule data schemas. Schemas 2810, 2820, and 2830 represent IF-state, ACTION, THEN-state schemas, respectively. Elements 2811 and 2812 correspond to Element 1 and Elements 2 to 4, respectively, among the above-described concept elements. For example, the element 2812 is described as “measurement amount > management amount + margin”. In this example, the “measurement amount” corresponds to Element 2, the “management amount” and the “margin” correspond to Element 3, and the inequality sign “>” corresponds to Element 4.

Elements 2821, 2822, and 2823 correspond to Elements 1, 2 to 4, and 5, respectively, among the above-described concept elements. Elements 2831 and 2832 correspond to Element 1 and Elements 2 to 4, respectively, among the above-described concept elements.

Back in FIG. 27, the generation module 102 searches, for example, the state information 121 stored in the storage unit 120 and extracts the state information including a concept identical to the extracted concept element (step S203). In addition, the generation module 102 searches for an element representing a location or a facility among concept elements corresponding to Element 1 and generates a relation link to the existing graph (for example, the graph 1201 in FIG. 12) including a location node representing the searched location or facility (step S204). The generated relation link is, for example, a predicate link connecting a subject node and an object node as follows.
Subject node: monitoring control target node (for example, chlorine in raw water in FIG. 12) included in the extracted state information
Object node: searched location node (for example, the “location_X” of the “tank_B” in FIG. 12)
Predicate link: PRESENT_IN

At steps S202 and S204, the generation module 102 may also search a range in which a concept element is not only completely identical but also similar, by the same scheme as that of the collation module 104.

The generation module 102 may solve inconsistency in description of a concept element before performing search.

The generation module 102 generates network graphs representing the IF state, the THEN state, and ACTION and mutually connects the network graphs, thereby generating the rule data (step S205).

The generation module 102 generates the network graphs as described below, for example.
IF-state network graph: connect a node (in FIG. 10, the node 1001) representing an IF condition to the state information having a root node at a node representing a monitoring control target related to the domain of the monitoring control system, through a relation link (such as the above-described “TARGET” or “HAS_ELEMENT”)
THEN-state network graph: connect a node (in FIG. 10, the node 1003) representing a THEN condition to the state information having a root node at a node representing a monitoring control target related to the domain of the monitoring control system, through a relation link (such as the above-described “TARGET” or “HAS_ELEMENT”)
ACTION: connect a root node (in FIG. 10, the node 1002) representing ACTION to the state information of a monitoring control target through a relation link

The generation module 102 generates the rule data by mutually connecting the generated IF-state, THEN-state, and ACTION root nodes through relation links (such as the above-described “CAUSE”, “ACT”, “DOWN”, “UP”, and “NULL”).

The generation module 102 may generate the rule data as a candidate and may store the generated state information in, for example, the rule data 122 in the storage unit 120 when registration of the candidate is designated by the user.

The output control module 105 may compare the existing rule data and the generated rule data and display a result of the comparison (step S206). For example, the output control module 105 collates a newly generated network graph to all existing rule data (network graphs) and outputs a collation result as follows. The user can determine whether to employ the generated rule data by referring to such a collation result.
(R1) Regarded as identical
(R2) Regarded as similar
(R3) Regarded as mismatch (includes inconsistency)
(R4) None of the above results is applied

The same procedure as that of the partial-identity determination or the similarity search as described above is applicable to determination of whether to regard as similar. The same procedure as that of the similarity search is applicable to determination of whether to regard as mismatch. For example, it is determined to regard as mismatch when the IF and THEN conditions are identical but the kind of a relation link from the ACTION node to the IF condition is opposite (for example, “DOWN” in the generated rule data but “UP” in the existing rule data). The concept that “DOWN” and “UP” have opposite meanings can be determined by referring to the ontology data as in the similarity determination.

The output control module 105 associates and displays the extracted rule data and the generated rule data. When registration of a displayed candidate is designated, the generation module 102 stores the designated candidate in the storage unit 120.

The following describes system data generation processing. The same procedure as that in FIG. 27 illustrating the rule data generation processing is also applicable to the system data. The case of the system data is different from the case of the rule data, for example, in the following points.
The original data is data in which a monitoring control log is recorded, and is, for example, table-format data (including a data table name, a data item, and external definition data).
The above-described element 5 (behavior concepts such as action, effect, and influence) is not extracted.
A predetermined schema is used for the system data.

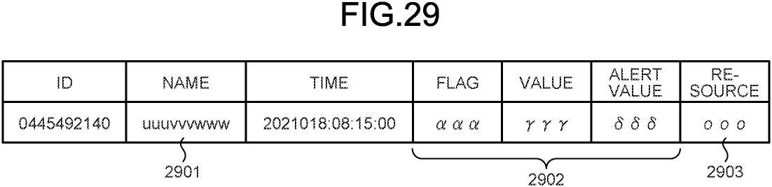

FIG. 29 is a diagram illustrating an exemplary system data schema. A schema 2901 corresponds to Elements 1, 2, and 4. A schema 2902 corresponds to Element 4. A schema 2903 corresponds to Elements 2 and 3.

FIG. 30 is a diagram illustrating an exemplary display screen 3001 on which generated data is displayed. Although FIG. 30 illustrates an example in which a candidate of the system data is displayed, the same screen may be displayed for the rule data.

As illustrated in FIG. 30, the display screen 3001 includes a candidate display region 3011, an edit button 3012, and a registration button 3013. The candidate display region 3011 displays a network graph of generated data, and text data representing the contents of the network graph.

When the edit button 3012 is pressed down, the output control module 105 displays, for example, an edit screen for editing data. When the registration button 3013 is pressed down, the generation module 102 stores the displayed candidate in the storage unit 120.

In this manner, in the present embodiment, collation uses the rule data and the system data expressed by using the state information. Accordingly, collation of data (the rule data and the system data) used for monitoring control can be more efficiently executed. Moreover, in the present embodiment, a collation condition such as the range of search using a network graph can be designated when collation is executed. Accordingly, for example, collation expanded to a similar range can be more easily achieved.

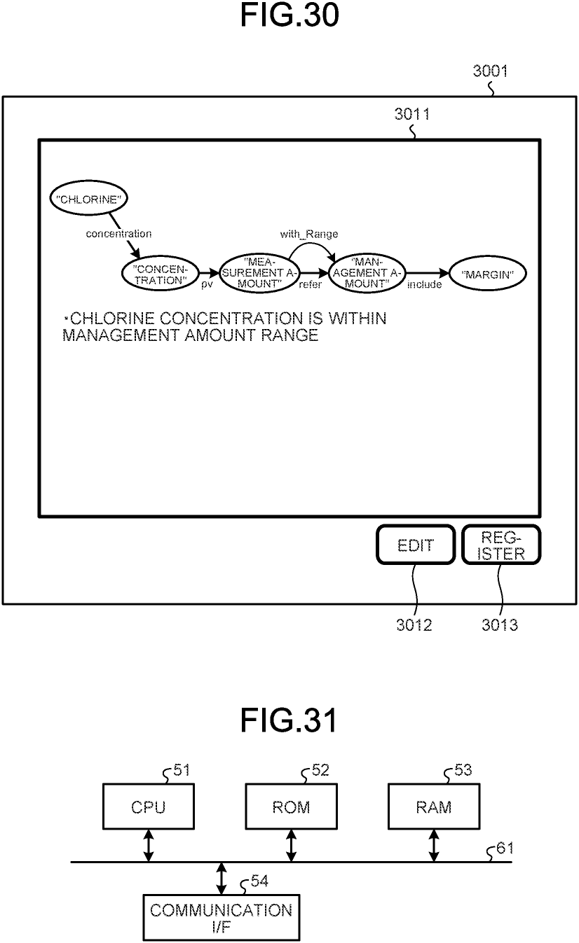

The following describes a hardware configuration of an information processing device according to the embodiment with reference to FIG. 31. FIG. 31 is an explanatory diagram illustrating an exemplary hardware configuration of the information processing device according to the embodiment.

The information processing device according to the embodiment includes a control device such as a CPU 51, storage devices such as a read only memory (ROM) 52 and a RAM 53, a communication I/F 54 for connection and communication through a network, and a bus 61 connecting the components.

A computer program to be executed by the information processing device according to the embodiment is incorporated in the ROM 52 or the like in advance and provided.

The computer program to be executed by the information processing device according to the embodiment may be recorded as a file in an installable or executable format in a computer-readable recording medium such as a compact disc read only memory (CD-ROM), a flexible disk (FD), a compact disc recordable (CD-R), or a digital versatile disc (DVD), and may be provided as a computer program product.

The computer program to be executed by the information processing device according to the embodiment may be stored on a computer connected with a network such as the Internet and may be provided by downloading through the network. The computer program to be executed by the information processing device according to the embodiment may be provided or distributed through a network such as the Internet.

The computer program to be executed by the information processing device according to the embodiment can cause a computer to function as each component of the above-described transmission device. The computer can be achieved by the CPU 51 reading the computer program from a computer-readable storage medium onto a main storage device and executing the computer program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising:
a memory; and
one or more processors coupled to the memory and configured to:
receive rule data and system data, the rule data representing rules of monitoring control and including one or more pieces of first state information among a plurality of pieces of state information by which states of one or more monitoring control targets are expressed in a relation between at least two concepts, the system data including one or more pieces of second state information among the plurality of pieces of state information and indicating a state of a first target included in a monitoring control system among the monitoring control targets;
determine a condition of collation between the plurality of pieces of state information;
collate, in accordance with the condition, the first state information included in the rule data and the second state information included in the system data; and
output a result of the collation to an output device.

2. The device according to claim 1, wherein
the plurality of pieces of state information are expressed in a network graph including a node and a link, the node being a concept, the link being connection between a plurality of concepts,
the rule data is expressed in a network graph including the one or more pieces of first state information, and
the system data is expressed in a network graph including the one or more pieces of second state information.

3. The device according to claim 2, wherein the condition includes a range of search of each of the network graphs.

4. The device according to claim 2, wherein each of the network graphs includes a knowledge graph including a subject node as a subject, an object node as an object, and a predicate link as a predicate connecting the subject node and the object node.

5. The device according to claim 4, wherein the predicate link includes a link meaning a behavior for state transition.

6. The device according to claim 4, wherein the predicate link includes a link having a property for link development.

7. The device according to claim 4, wherein the one or more processors are configured to output text data expressed in a natural language and including the subject expressed by the subject node, the object expressed by the object node, and the predicate expressed by the predicate link.

8. The device according to claim 7, wherein the one or more processors are configured to associate and output the knowledge graph included in a collation result and the text data generated based on the knowledge graph included in the collation result.

9. The device according to claim 1, wherein the one or more processors are configured to collate the system data including the second state information identical or similar to the first state information included in the rule data.

10. The device according to claim 1, wherein the state information indicates a relation between a first concept and a second concept, the first concept being a management amount as a basis of determination of whether the monitoring control targets are normal or abnormal, the second concept being one of a measurement amount, a statistic amount, a target amount, and an operation amount related to monitoring control of the monitoring control targets.

11. The device according to claim 10, wherein the one or more processors are configured to collate the system data including the second state information including the second concept identical to the second concept included in the first state information included in the rule data.

12. The device according to claim 1, wherein
the one or more processors are further configured to generate the plurality of pieces of state information from ontology data representing a concept system between a plurality of concepts including the monitoring control targets and the states of the monitoring control targets.

13. The device according to claim 1, wherein
the one or more processors are further configured to extract, from information indicating rules of monitoring control, a plurality of concepts in accordance with a predetermined schema indicating a structure of the rules of monitoring control, and generate the rule data including the first state information suitable for the extracted concepts among the plurality of pieces of state information.

14. The device according to claim 1, wherein
the one or more processors are further configured to extract, from information indicating the state of the first target, a plurality of concepts in accordance with a predetermined schema indicating a structure of data representing the states of the monitoring control targets, and generate the system data including the second state information suitable for the extracted concepts among the plurality of pieces of state information.

15. An information processing method executed by an information processing device, the method comprising:
receiving rule data and system data, the rule data representing rules of monitoring control and including one or more pieces of first state information among a plurality of pieces of state information by which states of one or more monitoring control targets are expressed in a relation between at least two concepts, the system data including one or more pieces of second state information among the plurality of pieces of state information and indicating a state of a first target included in a monitoring control system among the monitoring control targets;
determining a condition of collation between the plurality of pieces of state information;
collating, in accordance with the condition, the first state information included in the rule data and the second state information included in the system data; and
outputting a result of the collation to an output device.

16. A computer program product comprising a computer-readable medium including programmed instructions, the instructions causing a computer to execute:
receiving rule data and system data, the rule data representing rules of monitoring control and including one or more pieces of first state information among a plurality of pieces of state information by which states of one or more monitoring control targets are expressed in a relation between at least two concepts, the system data including one or more pieces of second state information among the plurality of pieces of state information and indicating a state of a first target included in a monitoring control system among the monitoring control targets;
determining a condition of collation between the plurality of pieces of state information;
collating, in accordance with the condition, the first state information included in the rule data and the second state information included in the system data; and
outputting a result of the collation to an output device.
